(19) United States
(12) Patent Application Publication
(10) Pub. No.: US 2018/0225770 A1
(43) Pub. Date: Aug. 9, 2018

(54) SYSTEMS AND METHODS FOR QUOTE CONTINUATION

(71) Applicant: Insurance Technologies Corporation, Carrollton, TX (US)

(72) Inventor: Laird Rixford, Irving, TX (US)

(21) Appl. No.: 15/426,890

(22) Filed: Feb. 7, 2017

(51) Int. Cl. G06Q 40/08

(52) U.S. Cl. CPC G06Q 40/08

(57) ABSTRACT

Systems and methods for providing quote continuation are disclosed. In embodiments, a consumer contacts an insurance entity (e.g., an insurance aggregator, insurance agent, etc.) to inquire about a quote for an insurance policy, and the insurance entity generates a plurality of quotes for the consumer. If the consumer does not purchase the insurance policy from the insurance entity during the initial interaction between the respective parties, the insurance entity, or a system of the insurance entity, may generate a notification to the consumer. The notification may include interactive elements that enable the consumer to: 1) review a set of quotes for the insurance policy; 2) purchase the insurance policy; and/or 3) rerate one or more of the quotes. The quotes included in the notification may include quotes for policies offered by different insurance carriers, thus, allowing the consumer to compare rates and policies quickly and easily.

### TECHNICAL FIELD

The present application is related generally to the technical field of insurance, and more particularly to systems and methods for providing quote continuation in connection with the purchase of an insurance policy.

### BACKGROUND

Consumers have many choices to make when purchasing insurance policies. For example, consumers can purchase insurance policies for a variety of purposes, such as insurance policies to insure against the loss of, or damage to, a home, an automobile, a boat, or other types of insurance policies (e.g., life insurance, health insurance, etc.). Each of these types of insurance policies may be offered by many insurance carriers, and a same type of insurance policy (e.g., an automobile insurance policy) offered by different insurance carriers may differ in terms of coverage, cost, and the like. A consumer may shop a particular type of policy across multiple insurance carriers in an effort to find the “best” rate. Often consumers find the processing of shopping rates to be burdensome. For example, a consumer may need to visit a website, or contact an agent, associated with each respective insurance carrier in order to obtain a quote from each of the insurance carriers. Upon visiting each website or contacting each agent, the consumer may be required to provide information (e.g., consumer's name, address, demographic information, vehicle information, other information, or a combination thereof) prior to obtaining the quote. The need to provide information, which is often overlapping to some degree, to each insurance carrier, whether provided via each respective insurance carrier's website or agent, may cause the consumer to become discouraged, resulting in the consumer purchasing an insurance policy from one of the insurance carriers based on a desire to end the process of shopping around for the best policy, rather than as a result of the consumer being satisfied with the policy that they ultimately purchased.

### SUMMARY

Insurance aggregators provide consumers with an alternative to manually shopping insurance policies by visiting websites and/or talking to agents of the respective insurance carriers individually. For example, an insurance aggregator may be affiliated with multiple insurance carriers, and may be able to provide a consumer with multiple quotes for a same insurance policy, where each of the quotes may correspond to a quote from a different insurance carrier to which the insurance aggregator is affiliated. However, insurance aggregators are faced with many challenges in connection with providing information regarding insurance policies, and ultimately selling an insurance policy to a consumer. For example, after the insurance aggregator has collected policy information (e.g., a desired type of insurance policy, a desired type of coverage, policy limits, target premium or cost, etc.) from the consumer and determined one or more policies that satisfy the policy information, the insurance aggregator may provide one or more quotes corresponding to the determined one or more policies to the consumer. After receiving the one or more quotes, the consumer may indicate to the insurance aggregator that he/she needs time to think about the policies. When this happens, the insurance aggregator must balance following up with the consumer to close the sale and allowing the consumer sufficient time to consider the various policies. If the insurance aggregator waits too long to follow up, the insurance aggregator runs the risk of the consumer bypassing the insurance aggregator and purchasing the policy from the insurance carrier directly or a quote from another source, causing the insurance aggregator to not get credit for the sale. However, if the insurance aggregator follows up too quickly or too often, the consumer may become frustrated and view the insurance aggregator as being too pushy, which may in turn result in the consumer purchasing a policy from the insurance carrier directly or a quote from another source, and the insurance aggregator does not receive credit for the sale.

The present disclosure is directed to systems and methods for facilitating quote continuation techniques that provide effective ways to follow up with consumers regarding quotes for insurance policies. In embodiments, policy information is received in connection with an inquiry for obtaining a quote for an insurance policy, and, based on the policy information, a plurality of quotes are generated. The plurality of quotes correspond to quotes for the insurance policy from a plurality of different insurance carriers. At least one quote of the plurality of quotes may be communicated to the consumer. For example, an agent of an insurance aggregator may discuss at least one of the quotes with the consumer in person or over the telephone. As another example, the insurance aggregator may provide at least one of the quotes to the consumer via an e-mail message.

Subsequently, a determination may be made regarding whether the consumer has purchased an insurance policy corresponding to one of the plurality of quotes. If the consumer has purchased an insurance policy corresponding to one of the plurality of quotes, the insurance aggregator may take steps to provide information to the consumer regarding the purchased insurance policy, but no further action is needed with respect to the other quotes. However, in response to a determination that the consumer has not made a purchase corresponding to one of the plurality of quotes, a notification may be generated that includes information representative of a set of quotes and that includes one or more interactive elements. The set of quotes may be selected from among the plurality of quotes (e.g., by the agent of the insurance aggregator or by a system executing software configured according to one or more of the disclosed embodiments). The notification may be an e-mail message, a text message, a multimedia message, or another type of message.

In embodiments, the one or more interactive elements may include various types of links that the consumer may interact with to complete a purchase of, or obtain updated information about, an insurance policy corresponding to one of the quotes. A first type of link, when selected, may navigate the consumer's device to a web page or other source where the consumer can purchase the insurance policy. A second type of link, when selected, may navigate the consumer to a web page or other source where the consumer can provide additional information to update the quote for the insurance policy. Each of the interactive elements may correspond to a different quote for the insurance policy, and, by including the interactive elements in the notification, the consumer, upon receiving the notification, can quickly review multiple quotes for the insurance policy at their own pace without feeling pressured by a sales person.

Because multiple quotes are represented in the notification, consumers may be more satisfied that they have “shopped around” for the “best” insurance policy, and that they are obtaining a policy that satisfies their policy goals (as expressed in the policy information used to generate the quotes). Additionally, because the consumer only had to provide the policy information to a single source (e.g,. the agent of the insurance aggregator), the process of shopping for the insurance policy may be less frustrating. Thus, embodiments of the present disclosure provide many benefits to consumers interested in purchasing insurance policies. In addition to the benefits provided to the consumers, the embodiments of the present disclosure provide several advantages to insurance aggregators. For example, by sending notifications including interactive elements that, when interacted with by the consumer, navigate the consumer's device to a web page where the consumer can purchase the policy, the likelihood that consumers purchase a policy and that the insurance aggregator completes the sale may be increased. Additionally, when more information is needed, such as when the duration of time between the notification and the original inquiry by the consumer causes some of the information used to generate the quote to become stale, interactive elements of the second type allow for the capturing of updated information in a manner that is likely to result in the consumer providing the information and completing the purchase of the insurance policy.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure, reference is now made to the following descriptions taken in conjunction with the accompanying drawing, in which:

FIG. 1 is a block diagram of an embodiment of a system for providing quote continuation; and

FIG. 2 is a flow diagram of an embodiment of a method for providing quote continuation.

### DETAILED DESCRIPTION OF THE INVENTION

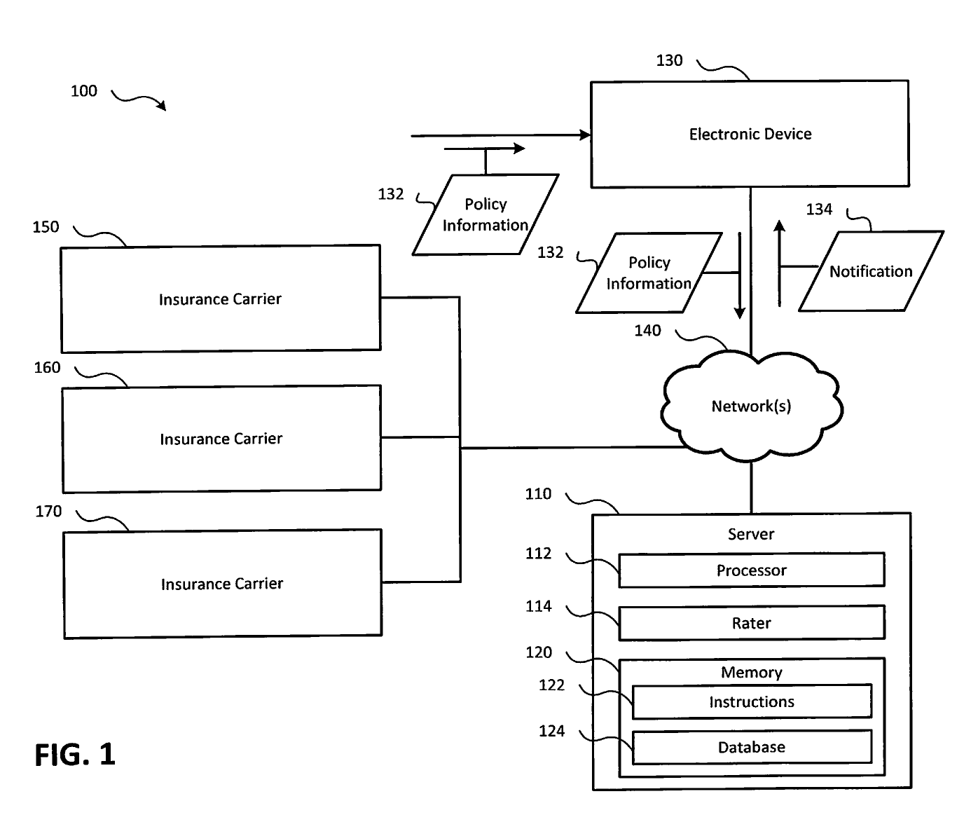

Referring to FIG. 1, an embodiment of a system for providing quote continuation is shown as a system 100. As shown in FIG. 1, the system 100 includes a server 110, an electronic device 130, and a plurality of insurance carrier devices 150, 160, 170. The server 110 may be communicatively coupled to the electronic device 130, and to the plurality of insurance carrier devices 150, 160, 170 via a network 140. In embodiments, the network 140 may include one or more networks. For example, the network 140 may include wired networks, wireless networks, local area networks (LANs), wireless LANs (WLANs), wide area networks (WANs), metropolitan area networks (MANs), cellular networks, public networks (e.g., the Internet), private networks, other network types and topologies, or a combination thereof.

The server 110 includes a processor 112, a rater engine 114, and a memory 120. The processor 112 may include a single processor, or multiple processors, each of which may include a single processing core, multiple processing cores, or a combination thereof. The rater engine 114 may be configured to generate and/or rank quotes for an insurance policy, as described in more detail below. In embodiments, operations of the rater engine 114 may be performed by the processor 112 while executing at least a portion of the instructions 122. In embodiments, the rater engine 114 may include dedicated processing components (e.g., a processor that is distinct from the processor 112, a field programmable gate array (FPGA), application specific integrated circuit(s) (ASIC(s)), circuitry, or other logic, a memory, etc.) configured to perform the operations of the rater engine 114. Implementing the rater engine 114 using dedicated processing components may increase the cost of the server 110, but may enable to the server 110 to process more information (e.g., more requests for quotes, etc.). Conversely, implementing the rater engine 114 as instructions executed by the processor 112 may reduce the cost of the server 110.

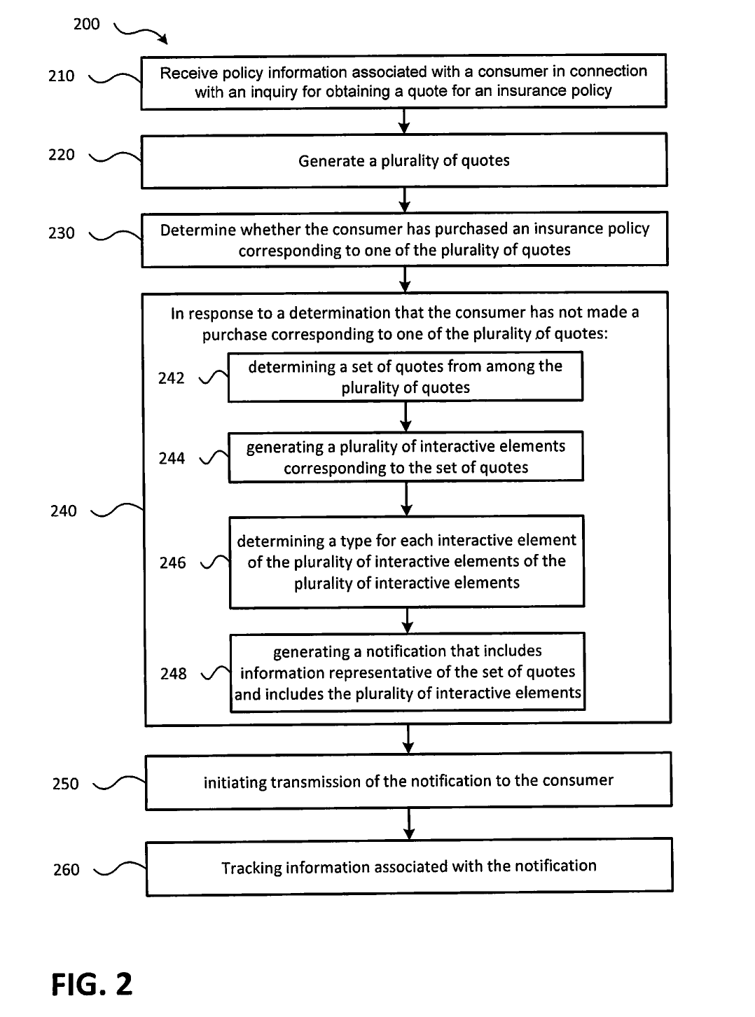

The memory 120 may include random access memory (RAM) devices, read-only memory (ROM) devices, flash memory devices, hard disk drives (HDDs), solid state drives (SSDs), or other memory devices configured to store information in a persistent or non-persistent state. In embodiments, the memory 120 may store instructions 122 that, when executed by the processor 112, cause the processor 112 to perform the operations for providing quote continuation operations, as described in in more detail below with reference to FIGS. 1 and 2. In embodiments, the memory 120 may store a database 124 of information that may be used to support the operations of the server 110. In embodiments, the database 124, or a portion thereof, may be stored at a memory external to the server 110, such as at a network attached storage (NAS) device, a remote database server, or another device accessible to the server 110. Exemplary information that may be stored at the database 124 and used to support the operations of the server 110 is described in more detail below.

In embodiments, the server 110 may be a web server configured to provide a web page that includes a user interface adapted to capture information (e.g., policy information 134) from a user (e.g., an operator of the electronic device 130) in connection with a request by a consumer for a rate quote for one or more insurance policies provided by one or more insurance carriers (e.g., operators of the plurality of insurance carrier devices 150, 160, 170). In embodiments, the user may be the consumer who is inquiring about a quote for an insurance policy. In embodiments, the user may be an insurance agent or employee of an insurance agency, an insurance carrier, an agent of an insurance aggregator, etc. that has been contacted by the consumer in connection with the inquiry regarding a quote for an insurance policy. The user may access the web page using a web browser application executing on the electronic device 130. In embodiments, the server 110 may be configured to support operations of an application executing on the electronic device 130 (e.g., a mobile application, a desktop application, etc.), where the application provides the user interface adapted to capture the policy information provided by the consumer (e.g., either to the application directly, or to an agent of an insurance carrier or insurance aggregator) in connection with the inquiry regarding the quote for an insurance policy. Additional aspects of the operations of the server 110 are described in more detail below. In embodiments, the server 110 may be operated by an insurance aggregator that is affiliated with each of the plurality of insurance carriers, and that sells insurance policies to consumers on behalf of the affiliated insurance carriers. In embodiments, the server 110 may be operated by one of the plurality of insurance carriers, and may offer rate quote services to consumers with respect to the purchase of an insurance policy, where the rate quote services include providing a consumer with a quote for an insurance policy offered by the insurance carrier operating the server 110, and providing the consumer with one or more quotes for the insurance policy from other insurance carriers of the plurality of insurance carriers.

In embodiments, the electronic device 130 may be a personal computing device, a laptop computing device, a tablet computing device, a smartphone, a personal digital assistant, or another electronic device configured to perform the operations described in connection with the electronic device 130 with reference to FIGS. 1 and 2. Although not illustrated in FIG. 1, the electronic device 130 may include a processor and a memory. The memory may store instructions that, when executed by the processor, cause the processor to perform the operations described in connection with the electronic device 130 with reference to FIGS. 1 and 2. For example, the instructions stored in the memory of the electronic device 130 may include instructions that, when executed by the processor of the electronic device 130, cause the processor to execute operations for an application adapted to provide a user interface to the user, where the user interface is configured to capture policy information associated with an inquiry for a quote for an insurance policy, as described in more detail below.

In FIG. 1, the plurality of insurance carrier devices are shown as including a first insurance carrier device 150, a second insurance carrier device 160, and a third insurance carrier device 170. However, it is noted that embodiments of the present disclosure are not limited to the number of insurance carrier devices shown in FIG. 1. For example, in additional or alternative embodiments of the present disclosure, the plurality of insurance carrier devices may include more than three insurance carrier devices or less than three insurance carrier devices. In embodiments, each of the plurality of insurance carrier devices may be configured to receive requests for quotes from the server 110, and, in response to receiving the requests for quotes, providing one or more quotes for an insurance policy corresponding to the request to the server 110. Each of the plurality of insurance carriers (e.g., operators of the insurance carrier devices) may offer one or more insurance policies to consumers. The insurance policies may include automobile insurance, life insurance, disability insurance, renter's insurance, flood insurance, home insurance, health insurance, other types of insurance policies, insurance policy riders, and the like. Some of the insurance policies, such as automobile insurance and home insurance, may be offered by all or many of the plurality of insurance providers, while other insurance policies may be specific to a few of the plurality of insurance providers. Each of the insurance policies may be associated with a rate (e.g., a premium paid periodically to the insurance carrier by the consumer in exchange for receiving coverage under an insurance policy). To purchase an insurance policy, the consumer may be required to provide information to an insurance carrier(s), where the information is used by the insurance carrier to determine the rate to be quoted to the consumer for the requested insurance policy.

During operation, policy information 132 may be received at the electronic device 130 in connection with an inquiry for obtaining a quote for an insurance policy. In embodiments, the policy information may include policy limits information, policy type information (e.g., automobile insurance, health insurance, home owner's or renter's insurance, life insurance, etc.), consumer information (e.g., the consumer's name, address, telephone number, e-mail address, age, birthdate, medical history information, social security number), vehicle information (e.g., make, model, yin number, color, year, etc.), or other information relevant to generating a quote for an insurance policy. Each policy type may be associated with a threshold level of information requirements that specify the information that must be provided in order to obtain or provide a quote for a particular insurance policy or policy type. The policy information 132 may vary according to the type of insurance policy that the consumer is inquiring about, and applications configured to capture the policy information 132 may be configured to prompt the user (e.g., the insurance aggregator or consumer) to provide the threshold level of information required to provide a quote for a specific insurance policy type. For example, if the consumer is inquiring about an automobile insurance policy, the policy information 132 may include vehicle information and consumer information (excluding medical history information). As another example, if the consumer is inquiring about a life insurance policy, the policy information 132 may include the consumer information (including the medical history information) and may not include the vehicle information. In embodiments, the database 124 may store information that indicates, for each insurance policy type offered by each of the respective insurance carriers, the threshold level of information (e.g., what should be included in the policy information 132) that is needed in order to provide a reliable quote.

In embodiments, the electronic device 130 may be an electronic device (e.g., mobile device, computing device, etc.) of the consumer, and the policy information 132 may be received at the electronic device 130 via inputs provided by the consumer using one or more input/output devices (e.g., a touch screen input device, a keyboard, a mouse, a voice recognition capability, and the like) coupled to, or integrated within, the electronic device 130. For example, an application (e.g., a mobile application or a web browser based application) executing on the electronic device 130 may present a graphical user interface that prompts the consumer to provide the policy information 132. In embodiments, the electronic device 130 may be an electronic device of an insurance aggregator (or an insurance agent, etc.), and the policy information 132 may be provided to the electronic device 130 by the insurance aggregator, who may be in communication with the consumer (e.g., the insurance aggregator may communicate with the consumer in person, over the phone, via a text messaging application, via an e-mail message, and the like), and who may receive the policy information 132 from the consumer. In embodiments, the application (e.g., a mobile application or a web browser based application) executing on the electronic device 130 may present a graphical user interface that prompts the insurance aggregator to collect the policy information 132 from the consumer and to populate the graphical user interface with the policy information 132 responsive to feedback from the consumer. In embodiments, the application (e.g., either the application executing on the consumer's electronic device or the insurance aggregator's electronic device) may communicate with the server 110 periodically to retrieve information (e.g., the threshold information requirements for various insurance policies from the respective insurance carriers, graphical user interface information/updates, etc.) from the database 124.

The electronic device 130 may provide the policy information 132 to the server 110 via the network 140. The server 110 may receive the policy information 132 in connection with the consumer's inquiry for obtaining the quote for the insurance policy. In embodiments, the policy information 132 may be stored as an entry in the database 124. In embodiments, the server 110 may generate a plurality of quotes in response to receiving the policy information 132. The plurality of quotes may be generated based at least in part on the policy information 132. In embodiments, the plurality of quotes may be generated based on information exchanged between the server 110 and the plurality of insurance carrier devices. For example, the server 110 may analyze the policy information 132 to identify the policy type associated with the consumer's inquiry, and may then identify a set of insurance carriers from among the plurality of insurance carriers that offer insurance policies of that policy type. After identifying the set of insurance carriers, the server 110 may transmit a request for a quote to insurance carrier devices corresponding to the set of insurance carriers, and, in response, may receive quotes from the set of insurance carriers. In embodiments, the quotes may be generated locally (e.g., at the server 110) based on information stored at the database 124. For example, the database 124 may store information representative of various quotes for insurance policies for one or more of the insurance carriers, where the quotes are based on policy information values. The information may be stored at the database 124 as a lookup table that indicates, for example, that policy information identifying a consumer having a particular set of demographic attributes (e.g., age range, gender, address or geographic location of residence, driving history, vehicle year/make/model/color, etc.) seeking a particular insurance policy type (e.g., automobile insurance) having a particular set of insurance policy attributes (e.g., policy limits, optional coverages such as hail, uninsured motorist, etc.) should be provided with a particular quote (e.g., the insurance policy inquired about by the consumer will cost “X” per “Y” time period). Thus, when the server 110 receives the policy information 132, the server 110 may access the database 124 to perform a lookup in the lookup table to generate quotes for the insurance carriers that offer the particular policy that the consumer inquired about. It is noted that the specific techniques for generating quotes described herein are provided for purposes of illustration, rather than by way of limitation, and other techniques for generating quotes may be utilized with one or more of the disclosed embodiments.

After the quotes are generated, at least one of the plurality of quotes may be communicated to the consumer. For example, the insurance aggregator may discuss one or more of the quotes with the consumer, or may provide one or more of the quotes to the consumer via mail, e-mail, or another medium. Subsequently, the server 110 may determine whether the consumer has purchased an insurance policy corresponding to one of the plurality of quotes. In embodiments, the determination of whether the consumer has purchased the insurance policy may be made based on information stored in the database 124, based on polling the various insurance carrier devices 150-170, or based on another technique.

In response to a determination that the consumer has not made a purchase corresponding to one of the plurality of quotes, the server 110 may generate a notification 134, and may initiate transmission of the notification 134 to the consumer, or more specifically, the consumer's electronic device. In embodiments, the notification may be an e-mail message, a text message, a multimedia message, another type of message, or a combination thereof. The notification 134 may include information representative of a set of quotes, where the set of quotes are selected from among the plurality of quotes generated in response to the consumer's inquiry. In embodiments, the set of quotes may include all of the generated quotes. In embodiments, the set of quotes may include a subset of the generated quotes (e.g., less than all of the generated quotes). For example, the set of quotes may include quotes that have been selected by the insurance aggregator. In embodiments, the insurance aggregator may select the set of quotes using the application executing on the electronic device 130.

In embodiments, the generated quotes may be provided to, or generated by, the rater engine 114. The rater engine 114 may be configured to rank the quotes according to one or more metrics. For example, the rater engine 114 may rank the quotes according to cost metrics, service metrics, coverage metrics, other metrics, or a combination thereof. The cost metrics may include metrics that enable the rater engine 114 to rank the generated quotes in terms of cost (e.g., based on premiums associated with the various insurance carriers corresponding to each of the generated quotes). The service metrics may include metrics that indicate a level of customer service provided by the various insurance carriers corresponding to each of the generated quotes, and may enable the rater engine 114 to rank the generated quotes according to the level of customer service that the consumer can expect to experience if an insurance policy corresponding to one of the generated quotes is purchased. The coverage metrics may indicate a level of coverage provided by each of the policies corresponding to the generated quotes, and may enable the rater engine 114 to rank the generated quotes according to the coverage provided by each of the policies corresponding to the generated quotes.

In embodiments, the information representative of the set of quotes may include value proposition information. For example, the value proposition information may indicate that, as between a first quote and a second quote for the insurance policy from different insurance carriers, the first quote is more expensive, but provides better coverage with respect to the second quote, or may indicate that the second quote while cheaper than the first quote, provides a lower level of service than the first quote. It is noted that other types of value propositions may be indicated in the notification, such as cost vs. customer service level. When consumers make purchases, they perceive that they received a better price when they are presented with choices for the purchase that have different prices. Thus, including value proposition information in the notification may increase the likelihood that the consumer: 1) purchases a policy based on the set of quotes included in the notification; and 2) is satisfied with the policy purchased. Additionally, this may cause the consumer to feel like he/she made an informed decision with respect to the quotes for the insurance policy.

In embodiments, the information representative of the set of quotes may include information that indicates one or more of the set of quotes need to be rerated. Quotes may need to be rerated for a variety of reasons. For example, automobile insurance policies typically become cheaper as consumers get older. Accordingly, one or more of the quotes may change if the consumer has had a birthday in between the time the plurality of quotes were generated and the time the notification is generated, or may be subject to change if the consumer is about to have a birthday. In some instances, the quotes may only change if the event (e.g., the consumer's birthday) has a particular characteristic (e.g., a threshold age). For example, automobile insurance policies are cheaper when the insured reaches certain age threshold (e.g., when the consumer turns 25), and are more expensive when the insured satisfies other age thresholds (e.g., when the insured is between the ages of 16-19 or after the insured turns 65). In embodiments, at the time the notification 134 is generated, the server 110 may determine whether an event that will affect the set of quotes has occurred or is about to occur. If such an event has occurred (e.g., between the time the quotes were generated and the time the notification is to be sent), or is going to occur within a threshold time period following the notification, the server 110 may determine that the affected quotes need to be rerated, and may include information within the notification indicating the particular quotes that need to be rerated, and may include information indicating that other quotes do not need to be rerated. It is noted that determining whether the any of the quotes need rerating based on age with respect to automobile insurance policies has been provided for purposes of illustration, rather than by way of limitation, and the present disclosure is not to be limited to rerating determinations based on automobile insurance policies and age. For example, embodiments may rerate insurance policies based on other factors, such as whether a claim has been made on an existing insurance policy, an amount of time that has elapsed since a claim under an existing insurance policy has been made, changes in the status of the health of the insured (e.g,. for a life or health insurance policy), or other events and factors that may affect the quote.

In embodiments, the information associated with the set of quotes may include, for each quote, a telephone number that the consumer may call to ask questions about a quoted insurance policy, and a description of the quoted insurance policy (e.g., policy limits, coverage provided by the insurance policy, the names of the insureds under the quoted insurance policy, a premium associated with the quoted insurance policy, etc.). In embodiments, the information associated with the set of quotes may include, for each quote, information associated with an existing insurance policy of the consumer. For example, if the consumer has an existing policy and is shopping for a new policy to replace the existing insurance policy, the information may indicate a date that a current insurance policy will be renewed, differences between the quoted insurance policy and the existing insurance policy, other information related to the existing insurance policy, or a combination thereof.

As explained above, the notification 134 may include a plurality of interactive elements. Each of the plurality of interactive elements may correspond to a respective quote included in the set of quotes. For example, if the set of quotes includes three quotes, the plurality of interactive elements may include three interactive elements, each corresponding to one of the quotes included in the set of quotes. In embodiments, the server 110 may generate the plurality of interactive elements based on the policy information, the set of quotes, or a combination thereof. In embodiments, the server 110 may determine a type for each interactive element of the plurality of interactive elements, wherein each of the plurality of interactive elements may be one of a first type of interactive element and a second type of interactive element.

The first type of interactive element may include a link that, when selected, navigates an electronic device to a web page that facilitates the purchase of the insurance policy corresponding to a respective quote of the set of quotes. The second type of interactive element may include a link that, when selected, navigates the electronic device to a web page that is configured to update information associated with the consumer in connection with updating (e.g., rerating) a respective quote of the set of quotes. In embodiments, each of the interactive elements of the first type may correspond to respective quotes of the set of quotes that do not require rerating, and each of the interactive elements of the second type may correspond to respective quotes of the set of quotes that require rerating.

In embodiments, the server 110, when generating the interactive elements, may analyze the policy information 132 and information associated with at least one insurance policy corresponding to one of the plurality of quotes to determine the type for each interactive element included in the notification 134. For example, during its analysis, the server 110 may determine whether the policy information 132 received from the consumer includes all information required for purchasing one or more of the policies. When the notification 134 is generated relatively quickly (e.g., within a few days or one week) after the policy information 132 is received, the policy information 132 is likely to have all of the information required for providing a highly accurate quote across all insurance carriers of the plurality insurance carriers that offer the type of insurance policy inquired about by the consumer (e.g., because the application executing on the electronic device 130 is configured to capture all required information based on requirements information stored in the database 124), and all interactive elements included in the notification 134 may be of the first type. However, when the notification 134 is generated after a threshold amount of time (e.g., after one week or perhaps longer) has elapsed since the policy information 132 is received, some of the policy requirements for one or more of the originally generated quotes may have changed (which would cause the requirements information stored in the database 124 to change), and, in such instances, the plurality of interactive elements included in the notification 134 may include interactive elements of the second type. In embodiments, the notification may include interactive elements of the first type and interactive elements of the second type (e.g., if information requirements for one or more insurance carriers have not changed with respect to the quoted insurance policy while other insurance carrier information requirements have changed). Thus, interactive elements of the first type correspond to quotes for which all information required for purchasing a corresponding policy have been received, and interactive elements of the second type correspond to quotes requiring additional information (and possibly rerating) before the consumer can purchase a corresponding policy.

In embodiments, the set of quotes included in the notification 134 may include at least one quote corresponding to an insurance policy satisfying all criteria specified by the policy information 132, and at least one quote that corresponds to an insurance policy that is selected as an alternative to the criteria specified by the policy information 132. For example, the policy information 132 may be associated with an inquiry for automobile insurance having a first set of policy specifications (e.g., policy limits, optional coverages, deductible, etc.). Thus, the set of quotes may include at least one quote for an insurance policy satisfying the first set, of policy specifications. However, the server 110 may determine one or more alternative sets of policy specifications (e.g., higher or lower policy limits, deductibles, etc., or a different set of optional coverages, etc.), and may generate one or more quotes associated with the one or more alternative sets of policy specifications. For example, the notification 134 may be generated to include tiered pricing quotes. The tiered pricing quotes may include at least one quote corresponding to an insurance policy satisfying all criteria specified by the consumer (e.g., at least one quote satisfying the first set of policy specifications), and at least one quote that corresponds to an insurance policy that is selected as an alternative to the criteria specified by the consumer (e.g., at least one quote corresponding to an insurance policy selected based on the one or more alternative sets of policy specifications). in embodiments, the alternative quote(s) may be determined based on the policy information 132. For example, the policy information 132 may include input from the consumer identifying preference rankings for service, cost, etc.

In embodiments, the at least one quote that corresponds to an insurance policy that is selected as an alternative to the criteria specified by the consumer may be associated with a better quality of service, a lower quality of service, a lower deductible, a higher deductible, a higher premium, a lower premium, a higher policy limit, a lower policy limit, a different set of optional coverages, or a combination thereof. Providing tiered pricing options for insurance policies that are different from the policy inquired about by the consumer may provide the consumer with additional options that may be more suited to the needs of the consumer. For example, the consumer may have inquired about an insurance policy having the first set of requirements, but one of the alternative tiered pricing quotes may be appropriate for the consumer's needs/goals with respect to the insurance policy, and may provide a more cost effective solution for the consumer's needs, or may provide better coverage at minimal additional cost Including tiered pricing quotes in the notification 134 may increase the likelihood that the consumer purchases one of the quoted insurance policies, and may increase the likelihood that the purchased insurance policy is satisfactory to the consumer.

After generating the notification 134, the server 110 may initiate transmission of the notification 134 to the consumer via the network 140. As explained above, the notification 134 may be an e-mail message, a text message, a multimedia message, another type of message, or a combination thereof. In embodiments, after transmitting the notification 134 to the consumer, the server 110 may be configured to track information associated with the consumer's interaction with one or more of the plurality of interactive elements. For example, the server 110 may track whether the consumer has purchased an insurance policy using one of the interactive elements of the first type, whether the consumer has interacted with, but not purchased an insurance policy using one of the plurality of interactive elements, whether the consumer has viewed the notification, whether the consumer has interacted with one of the plurality of interactive elements of the second type, other information associated with the notification, or a combination thereof. When the consumer interacts with one of the plurality of interactive elements, but does not complete the purchase, the server 110 may determine how far the consumer went in the purchase process. For example, whether the consumer stopped when prompted to login (e.g., at the start of the process), or whether the consumer stopped when prompted to provide the payment information.

The information tracked by the server 110 with respect to the notification 134 may be used to determine whether to take one or more actions with respect to the set of quotes included in the notification 134. For example, the server 110 may be configured to resend the notification 134 to the consumer in response to a triggering event. The triggering event may include detecting that the consumer has not interacted with any of the interactive elements included in the notification 134, detecting that the consumer has not viewed the notification 134, detecting that the consumer has not purchased an insurance policy corresponding to one of the quotes included in the notification 134, detecting that information included in the policy information 132 has become stale (e.g., needs to be updated in order to provide a more accurate quote than the one originally provided in the notification 134 that was initially sent to the consumer), detecting that an existing insurance policy of the consumer is about to expire, another event, or a combination thereof.

In embodiments, the notification 134 that is initially sent to the consumer may include only quotes satisfying the policy information 132, and, in response to detecting that the consumer has not interacted with the interactive elements, or has not viewed the notification 134, the server 110 may generate a second notification that includes tiered pricing quotes, as described above. This may be beneficial because the consumer's lack of action with respect to the initial notification 134 may indicate that the set of quotes were not to the consumer's satisfaction, and sending a second notification with tiered pricing quotes, as described above, may offer the consumer some alternative quotes that may be of more interest to the consumer. In embodiments, the second notification may be sent to the consumer in response to detecting that: 1) the consumer has not purchased a policy corresponding to one of the quotes; and 2) one or more of the quotes require rerating (e.g., at least a portion of the policy information 132 has become stale), as described above.

In embodiments, the second notification may be sent based on how far the consumer got in the purchase process. For example, when the tracking detects that the consumer ended the purchase process when prompted to log in, the server 110 may determine that there is a low probability of successfully selling the consumer an insurance policy, and may determine not to send the second notification, or to include tiered pricing quotes in the second notification which may be of more interest to the consumer. As another example, when the tracking detects that the consumer ended the purchase process when prompted to provide payment information, the server 110 may determine that the consumer was highly interested in the quote that the consumer interacted with, and may send a second notification that includes the quote that the consumer interacted with (and optionally one or more alternative quotes that are similar to the quote that the consumer interacted with but are associated with different costs and/or coverage terms).

In still another additional or alternative embodiment, the server 110 may be configured to record information associated with various tracked notification at the database 124, and the recorded information may be used to dynamically modify how notifications are created. For example, the server 110 may track information associated with notification, such as whether consumers interacted with the interactive elements, the type of interactive elements and quotes that consumers interacted with/purchased more often (e.g., interactive elements of the first type or the second type, tiered pricing or alternative quotes vs. quotes corresponding to the policy information 132 provided by the consumer, etc.), or other information to identify relationships between characteristics of consumers (e.g., age, income, types of insurance policies owned/inquired about, types of insurance policies recommended for consumers) and the quotes provided in the notifications.

For example, the server 110 may analyze the recorded information to determine whether consumers in a certain age range that have home and automobile insurance policies, but do not have life insurance and long term disability policies, are more likely to purchase life insurance policies than long term disability policies, or vice-versa. Such relationships may be used to determine whether particular consumers are more likely to respond to prospective notifications than other consumers, and may be further used to determine the types of quotes and recommendations that should be included in the prospective notifications for particular consumers. As another example, the recorded information may be used to identify characteristics of consumers that are more likely to interact with alternative quotes (e.g., tiered pricing quotes). Such information may be used to determine whether a notification sent to the consumer should include tiered pricing quotes (e.g., quotes having different policy limits, optional coverages, etc. that differ from the policy information 132). In some instances, the recorded information may be used to identify characteristics of consumers that are not likely to respond to, or interact with, notifications and/or prospective notifications. It is noted that the relationships and uses of the recorded information described above have been provided for purposes of illustration, rather than by way of limitation, and that the server 110 may identify other relationships and characteristics that are used to dynamically determine what information is included in notifications, and whether to send prospective notifications, etc. By recording the information in the database 124, the server 110 is able to make more intelligent decisions/recommendations with respect to notification content, thereby improving the effectiveness of the notifications and the consumer's experience.

Sending the second notification in response to detecting a triggering event may prevent frustration for the consumer, such as if the consumer finally decides to purchase a policy based on the initial notification 134, only to find out that the quotes were outdated (due to the consumer's delay in executing the purchase). Further, providing the consumer with the second notification which indicates that one or more of the quotes has changed may increase the consumer's satisfaction with the level of customer service provided by the insurance aggregator that provided the notifications, and may ensure that the most up-to-date quotes are presented for consideration by the consumer.

In embodiments, the server 110 may be configured to generate notifications, such as the notification 134 described above, in a prospective manner. That is, the server 110 may periodically analyze policy information, such as the policy information 132, or other information received from consumers to identify consumer that have one or more insurance policy needs. For example, the server 110 may analyze policy information received from the consumer (either in connection with a newly received inquiry for quotes for an insurance policy or in connection with an inquiry for quotes for an insurance policy received in the past) to identify what types of insurance policies the consumer has, and what types of other insurance policies may be of interest to the consumer. For example, the information may indicate that the consumer owns an automobile and a home, and has an automobile insurance policy and a home owner's policy (which may have been purchased using a notification as described briefly above, and as described in more detail below). However, the information may further indicate that the consumer is married, and has children, but does not have a life insurance policy. Thus, the server 110 may generate a prospective notification including information and interactive elements for one or more life insurance policy quotes, and may initiate transmission of the prospective notification to the consumer. When the server 110 generates a prospective notification, the server 110 may include information explaining the benefits of the insurance policy or policies suggested to the consumer in the notification. For example, a prospective notification suggesting a life insurance policy to the consumer and may include information describing how purchasing a life insurance policy may help provide for a family member in the event that something tragic happens to the consumer. Including information describing the benefits to the consumer that are provided by an insurance policy suggested in a prospective notification may help the consumer make an informed decision on whether such an insurance policy is appropriate for the consumer's needs/goals.

From the above, it has been shown that the system 100 of FIG. 1 facilitates the collection of information in connection with the purchase of an insurance policy, and provides techniques for automating communications (e.g., the notification 134) to the consumer to follow up on one or more quotes provided to the consumer in a non-invasive, low pressure manner. Additionally, as explained above, the operations of the system 100 generate notifications to the consumer that include multi-carrier quotes (e.g., quotes for an insurance policy from multiple insurance carriers) that are associated with interactive elements that facilitate the online purchase of an insurance policy by the consumer, thereby allowing the consumer to shop insurance policy rates amongst multiple insurance carriers in a simple and user-friendly way that does not result in frustration to the consumer, and that simplifies the follow up on the part of the entity providing the quotes. Additionally, utilizing embodiments of the present disclosure may increase the rate at which quotes for insurance policies are converted to purchases of insurance policies. For example, presently approximately twenty five percent of quotes for insurance policies close (e.g., result in a purchase of an insurance policy). One of the main reasons attributed to this close rate is that the consumer, upon receiving the quotes, needs to talk to someone (e.g., the consumer's spouse) before making purchasing the insurance policy. Thus, presently available techniques for following up with consumers to assist them with purchasing insurance policies are ineffective. However, embodiments of the present disclosure may increase the effective rate at which quotes are converted to insurance policy purchases, thereby increasing the number of consumers that are covered by the relevant types of insurance that meet the consumers' needs.

It is noted that although in FIG. 1 the server 110 is described as being operated by an insurance aggregator, in embodiments the server 110 may be operated by an entity other than an insurance aggregator. For example, the server 110 may be operated by an insurance agent, an insurance carrier, or another entity that provides insurance policy quotes to consumers. Further, it is noted although in FIG. 1 the policy information 132 is described as being received from the consumer (e.g., via an application executing on the consumer's electronic device or via an application executing on an insurance aggregator's electronic device based on information exchanged during a communication between the insurance aggregator and the consumer), in embodiments the policy information may be received from a lead aggregator or other entity that disseminates information regarding consumers that are interested in obtaining an insurance policy.

After being generated and transmitted by the server 110, the notification may be received by the consumer via the consumer's electronic device. Upon receiving the notification, the consumer may view the contents of the notification (e.g., the information representative of the set of quotes) and, upon identifying an insurance policy that the consumer desires to purchase, the consumer may interact with one of the interactive elements included in the notification to initiate the purchase of the insurance policy of interest. For example, if the insurance policy of interest is associated with an interactive element of the first type, the consumer may select the interactive element, which causes the electronic device of the consumer to navigate to a web page that facilitates the purchase of the insurance policy of interest. In embodiments, the web page may present the information required for the insurance policy (as retrieved or obtained from the policy information 132) to the consumer for validation purposes, and, if the information is valid (e.g., unchanged), the consumer may initiate the purchase of the insurance policy. If any of the information has changed, the consumer may be prompted to update the information in order to obtain an updated quote for the insurance policy of interest. Similarly, if the insurance policy of interest is associated with an interactive element that is of the second type, selection of the interactive element may cause the electronic device of the consumer to navigate to a web page that enables the consumer to obtain an updated (e.g., rerated) quote for the insurance policy of interest, which may include having the consumer update some of the policy information needed to provide the new quote. As can be seen, including the interactive elements in the notification provides a simple and efficient technique that enables the consumer to make a decision regarding which insurance policy to buy in a low pressure manner at a time that is convenient to the consumer, without requiring the consumer to interact with a sales person to complete the sale, and without requiring the sales person to hassle with multiple web sites and insurance carriers.

Referring the FIG. 2, a flow diagram of an exemplary embodiment of a method for providing quote continuation is shown as a method 200. In embodiments, the method 200 may be performed by the server 110 of FIG. 1. In embodiments, the various steps of the method 200 may be stored as instructions (e.g., the instructions 122 of FIG. 1) that, when executed by a processor (e.g., the processor 112 of FIG. 1), cause the processor to perform operations for providing quote continuation in accordance with the embodiments disclosed herein.

At 210, the method 200 includes receiving policy information associated with a consumer in connection with an inquiry for obtaining a quote for an insurance policy. The policy information may include policy limits information, policy type information, consumer information, policy ranking preferences (e.g., service, cost, etc.), or other information, as described above with respect to the policy information 132 of FIG. 1. At 220, the method 200 includes generating a plurality of quotes. As describe with reference to FIG. 1, the plurality of quotes may be generated based at least in part on the policy information, and at least one of the plurality of quotes is communicated to the consumer. In embodiments, the method 200 may include, at 230, determining whether the consumer has purchased an insurance policy corresponding to one of the plurality of quotes.

In response to a determination, at 240, that the consumer has not made a purchase corresponding to one of the plurality of quotes, the method 220 includes: determining a set of quotes from among the plurality of quotes, at 242; generating a plurality of interactive elements corresponding to the set of quotes, at 244; determining a type for each interactive element of the plurality of interactive elements of the plurality of interactive elements, at 246; and generating a notification that includes information representative of the set of quotes and includes the plurality of interactive elements, at 248. In embodiments, each of the plurality of interactive elements corresponds to a respective quote included in the set of quotes, and is one of a first type of interactive element and a second type of interactive element. As described with reference to FIG. 1, the first type of interactive element include a link that, when selected, navigates an electronic device to a web page that facilitates the purchase of an insurance policy corresponding to a respective quote of the set of quotes, and the second type of interactive element includes a link that, when selected, navigates the electronic device to a web page that is configured to update information associated with the consumer in connection with updating (or rerating) a respective quote of the set of quotes. In embodiments, the notification generated at 248 may be the notification 134 of FIG. 1, and may be an e-mail message, a text message, a multimedia message, or a combination thereof.

At 250, the method 200 includes initiating transmission of the notification to the consumer. In embodiments, the method 200 may include, at 260, tracking information associated with the notification. For example, as explained above with reference to FIG. 1, information associated with the notification that may be tracked includes: whether the consumer has interacted with any of the interactive elements included in the notification; how far the consumer got in the purchase or rerating process (e.g., did the consumer make a purchase or stop before the purchase was completed); whether the consumer has viewed the notification; whether information associated with the notification (e.g,. the policy information used to generate the quotes included in the notification) has become stale; or other information, as described above with reference to FIG. 1. In embodiments, the server may take one or more actions (e.g., send a second notification including updated quotes, etc.) in response to detecting triggering event, where the triggering event may be detected based, at least in part, on the information that is tracked. In embodiments, the method 200 may include recording tracked information in a database (e.g., the database 124 of FIG. 1), where the recorded information may be used to perform analytics operations for determining contents of notifications, and whether or not to send notifications to particular consumers, as described above with respect to FIG. 1.

Although the present disclosure and its advantages have been described in detail, it should be understood that various changes, substitutions and alterations can be made herein without departing from the scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the embodiments of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for providing quote continuation comprising
receiving, by a processor, policy information from a consumer in connection with an inquiry for obtaining a quote for an insurance policy;
generating, by the processor, a plurality of quotes, wherein the plurality of quotes are generated based at least in part on the policy information, and wherein at least one of the plurality of quotes is communicated to the consumer;
determining, by the processor, whether the consumer has purchased an insurance policy corresponding to one of the plurality of quotes;
in response to a determination that the consumer has not made a purchase corresponding to one of the plurality of quotes, generating, by the processor, a notification, wherein the notification includes information representative of a set of quotes and includes plurality of interactive elements, wherein the set of quotes includes quotes selected from among the plurality of quotes, and wherein each of the plurality of interactive elements corresponds to a respective quote included in the set of quotes; and
initiating, by the processor, transmission of the notification to the consumer.

2. The method for providing quote continuation of claim 1, wherein the method includes providing the policy information to a comparative rater, wherein the comparative rater generates the plurality of quotes.

3. The method of claim 1, wherein the notification is an e-mail message, a text message, a multimedia message, or a combination thereof.

4. The method of claim 1, wherein the one or more interactive elements are one of a first type of interactive element and a second type of interactive element, and wherein the method includes determining a type for each of the one or more interactive elements included in the notification.

5. The method of claim 4, wherein the first type of interactive element includes a link that, when selected, navigates an electronic device to a web page that facilitates the purchase of an insurance policy corresponding to a respective quote of the set of quotes, and wherein the second type of interactive element includes a link that, when selected, navigates the electronic device to a web page that is configured to update information associated with the consumer in connection with updating a respective quote of the set of quotes.

6. The method of claim 5, wherein the method includes analyzing the policy information and information associated with at least one insurance policy corresponding to one of the plurality of quotes to determine a type for each interactive element included in the notification.

7. The method of claim 6, wherein the analyzing includes determining whether the policy information includes all information required for purchasing one or more of the insurance policies, and wherein interactive elements corresponding to quotes for which all information required for purchasing one or more of the insurance policies are of the first type.

8. The method of claim 6, wherein the analyzing includes determining whether the policy information includes all information required for purchasing one or more of the insurance policies, and wherein interactive elements corresponding to quotes for which not all information required for purchasing one or more of the insurance policies are of the second type.

9. The method of claim 1, wherein the set of quotes includes at least one quote corresponding to an insurance policy satisfying all of the policy information, and at least one quote that corresponds to an insurance policy that is selected as an alternative to insurance policies satisfying the policy information.

10. The method of claim 9, wherein the policy information includes policy limits information, and wherein the at least one quote corresponding to an insurance policy that is selected as an alternative to insurance policies satisfying the policy information is for an insurance policy having policy limits that are different from the policy limits information.

11. The method of claim 1, wherein the set of quotes includes tiered pricing quotes, wherein the tiered pricing quotes include at least one quote corresponding to an insurance policy satisfying all criteria specified by the consumer, and at least one quote that corresponds to an insurance policy that is selected as an alternative to the criteria specified by the consumer, and wherein the at least one quote that corresponds to an insurance policy that is selected as an alternative to the criteria specified by the consumer is associated with a better quality of service, a lower quality of service, a lower deductible, a higher deductible, a higher premium, a lower premium, a higher policy limit, a lower policy limit, or a combination thereof.

12. The method of claim 11, wherein the notification includes information indicating a value proposition for each quote included in the set of quotes.

13. The method of claim 1, wherein the method includes resending the notification in response to a triggering event.

14. The method of claim 1, wherein the method includes tracking information associated with the consumer's interaction with the one or more interactive elements.

15. A non-transitory computer-readable storage medium including instructions that, when executed by a processor, cause the processor to perform operations for providing quote continuation, the operations comprising:
receiving policy information associated with a consumer in connection with an inquiry for obtaining a quote for an insurance policy, wherein the policy information includes policy limits information, a policy type information, and consumer information;
generating a plurality of quotes, wherein the plurality of quotes are generated based at least in part on the policy information, and wherein at least one of the plurality of quotes is communicated to the consumer;
determining whether the consumer has purchased an insurance policy corresponding to one of the plurality of quotes;
in response to a determination that the consumer has not made a purchase corresponding to one of the plurality of quotes:
determining a set of quotes from among the plurality of quotes;
generating a plurality of interactive elements corresponding to the set of quotes, wherein each of the one or more interactive elements corresponds to a respective quote included in the set of quotes;
determining a type for each interactive element of the plurality of interactive elements of the plurality of interactive elements, wherein each of the plurality of interactive elements is one of a first type of interactive element and a second type of interactive element, wherein the first type of interactive element includes a link that, when selected, navigates an electronic device to a web page that facilitates the purchase of an insurance policy corresponding to a respective quote of the set of quotes, and wherein the second type of interactive element includes a link that, when selected, navigates the electronic device to a web page that is configured to update information associated with the consumer in connection with updating a respective quote of the set of quotes; and
generating a notification that includes information representative of the set of quotes and includes the plurality of interactive elements, wherein the notification is an e-mail message, a text message, a multimedia message, or a combination thereof, wherein the notification; and
initiating transmission of the notification to the consumer.

16. The non-transitory computer-readable storage medium of claim 15, wherein the operations include analyzing the policy information and information associated with at least one insurance policy corresponding to one of the plurality of quotes to determine the type for each interactive element included in the notification.

17. The non-transitory computer-readable storage medium of claim 16, wherein the analyzing includes determining whether the policy information received from the consumer includes all information required for purchasing one or more of the policies, wherein interactive elements of the first type correspond to quotes for which all information required for purchasing a corresponding policy have been received, and wherein interactive elements of the second type correspond to quotes requiring additional information before the consumer can purchase a corresponding policy.

18. The non-transitory computer-readable storage medium of claim 15, wherein the set of quotes includes at least one quote corresponding to an insurance policy satisfying all criteria specified by the policy information, and at least one quote that corresponds to an insurance policy that is selected as an alternative to the criteria specified by the policy information.

19. An apparatus comprising:
one or more processors configured to:
receive policy information associated with a consumer in connection with an inquiry for obtaining a quote for an insurance policy, wherein the policy information includes policy limits information, a policy type information, and consumer information;
generate a plurality of quotes, wherein the plurality of quotes are generated based at least in part on the policy information, and wherein at least one of the plurality of quotes is communicated to the consumer;
determine whether the consumer has purchased an insurance policy corresponding to one of the plurality of quotes;
in response to a determination that the consumer has not made a purchase corresponding to one of the plurality of quotes:
determine a set of quotes from among the plurality of quotes;
generate a plurality of interactive elements corresponding to the set of quotes, wherein each of the one or more interactive elements corresponds to a respective quote included in the set of quotes;
determine a type for each interactive element of the plurality of interactive elements of the plurality of interactive elements, wherein each of the plurality of interactive elements is one of a first type of interactive element and a second type of interactive element, wherein the first type of interactive element includes a link that, when selected, navigates an electronic device to a web page that facilitates the purchase of an insurance policy corresponding to a respective quote of the set of quotes, and wherein the second type of interactive element includes a link that, when selected, navigates the electronic device to a web page that is configured to update information associated with the consumer in connection with updating a respective quote of the set of quotes; and
generate a notification that includes information representative of the set of quotes and includes the plurality of interactive elements, wherein the notification is an e-mail message, a text message, a multimedia message, or a combination thereof, wherein the notification; and
initiate transmission of the notification to the consumer; and
a memory coupled to the one or more processors.

20. The apparatus of claim 19, wherein the information representative of the set of quotes includes value proposition information associated with the set of quotes.
